(19) United States
(12) Patent Application Publication
(10) Pub. No.: US 2026/0356178 A1
(43) Pub. Date: Nov. 12, 2026

(54) VEHICLE FRONT STRUCTURE

(71) Applicant: Honda Motor Co., Ltd., Tokyo (JP)

(72) Inventors: Takahiro KASAHARA, Saitama (JP); Nobuyuki IRIE, Tokyo (JP); Yasuhiro OKI, Tokyo (JP); Hisashi KONOURA, Tokyo (JP); Mutsuo TEZUKA, Tokyo (JP)

(73) Assignee: Honda Motor Co., Ltd., Tokyo (JP)

(21) Appl. No.: 19/467,732

(22) Filed: Feb. 2, 2026

(30) Foreign Application Priority Data
May 9, 2025 (CN) 202510592268.7

(51) Int. Cl. B60K 1/00; B60K 17/16; B62D 21/15

(52) U.S. Cl. CPC B60K 1/00; B60K 17/16; B62D 21/157

(57) ABSTRACT

A vehicle front structure that may expand a cabin space and has good structural rigidity is provided in the disclosure. The vehicle front structure includes: a side frame, provided with an accommodating portion, and at least a portion of an electric motor for driving a vehicle is accommodated in the accommodating portion; and a mounting bracket, equipped with mounting parts for elastically supporting the electric motor. The mounting bracket is configured to span a front portion and a rear portion of the accommodating portion.

### CROSS-REFERENCE TO RELATED APPLICATION

This application claims the priority benefit of China application serial no. 202510592268.7, filed on May 9, 2025. The entirety of the above-mentioned patent application is hereby incorporated by reference herein and made a part of this specification.

### BACKGROUND

### Technical Field

The disclosure relates to a vehicle structure.

### Description of Related Art

In the prior art, Patent Document 1 (Japanese Patent No. 2005-199894) discloses a vehicle body structure in which motor components are placed on the inside of the front side frames on both the left and right sides, thus forming a larger space between the left and right front side frames. This allows the interior space of the vehicle, for example, the cabin, to be expanded towards the front compartment accommodating the motor components, thereby ensuring a larger cabin. However, the challenge that remains is how to further expand the space between the left and right front side frames without compromising the rigidity of the vehicle body structure.

This case aims to address the aforementioned challenge with the objective of expanding the cabin space while maintaining the rigidity of the vehicle body structure. Moreover, it further contributes to the development of sustainable transportation systems.

### SUMMARY

A vehicle front structure that may expand a cabin space and has good structural rigidity is provided in the disclosure.

According to an embodiment of the disclosure, the vehicle front structure includes a side frame and a mounting bracket. The side frame is provided with an accommodating portion, and at least a portion of an electric motor for driving a vehicle is accommodated in the accommodating portion. The mounting bracket is equipped with mounting parts for elastically supporting the electric motor. The mounting bracket is configured to span a front portion and a rear portion of the accommodating portion.

Based on the above, in an embodiment of the disclosure, the space between the left and right side frames may be increased by accommodating at least a portion of the electric motor in the accommodating portion of the vehicle front structure. This allows the interior space of the vehicle, for example, the cabin, to be expanded towards the front compartment accommodating the electric motor, thereby ensuring a larger cabin. Furthermore, the mounting bracket may simultaneously function as a support component for mounting the electric motor and a reinforcement component for reinforcing the structure. This prevents a reduction in the structural strength of the side frame due to the configuration of an accommodating portion within the side frame, and ensures structural rigidity while assembling the components in a more compact manner, while simultaneously satisfying the ease of assembly and installation functionality.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a vehicle front structure according to an embodiment of the disclosure.

FIG. 2 is a side view schematic diagram of the vehicle front structure shown in FIG. 1.

FIG. 3 is a partially enlarged schematic diagram of the vicinity of the connecting rigid component of the vehicle front structure shown in FIG. 1.

FIG. 4 is a top view schematic diagram of the vicinity of the connecting rigid component of the vehicle front structure shown in FIG. 1.

FIG. 5A and FIG. 5B are partial schematic diagrams of some mounting parts on the mounting bracket of the vehicle front structure shown in FIG. 1.

FIG. 6 is a schematic diagram of the vehicle front structure shown in FIG. 1 equipped with a control unit.

### DETAILED DESCRIPTION OF DISCLOSED EMBODIMENTS

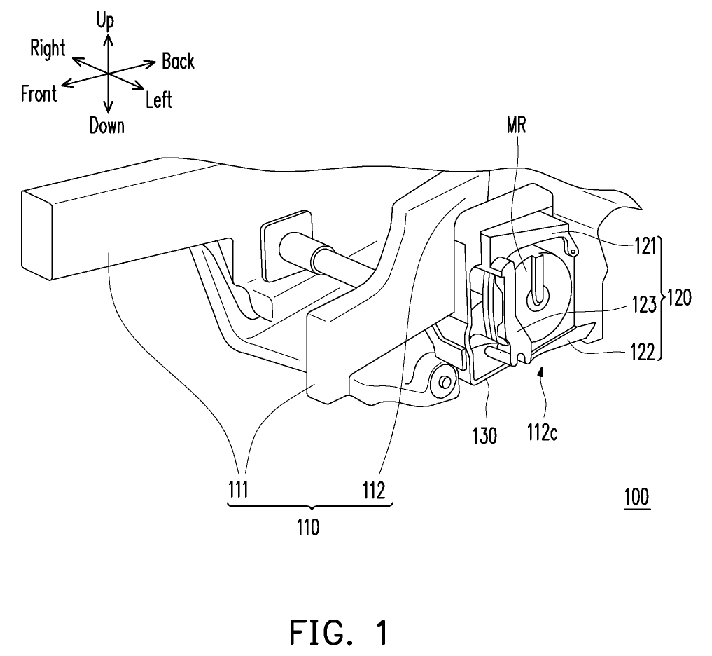

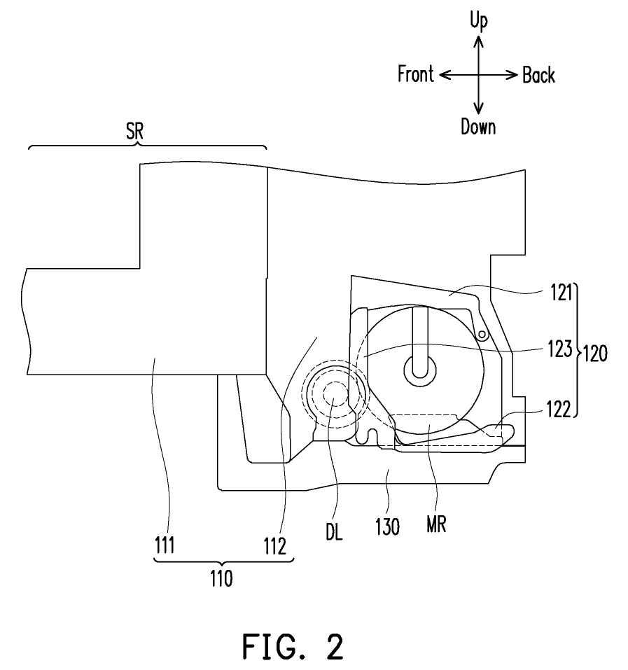

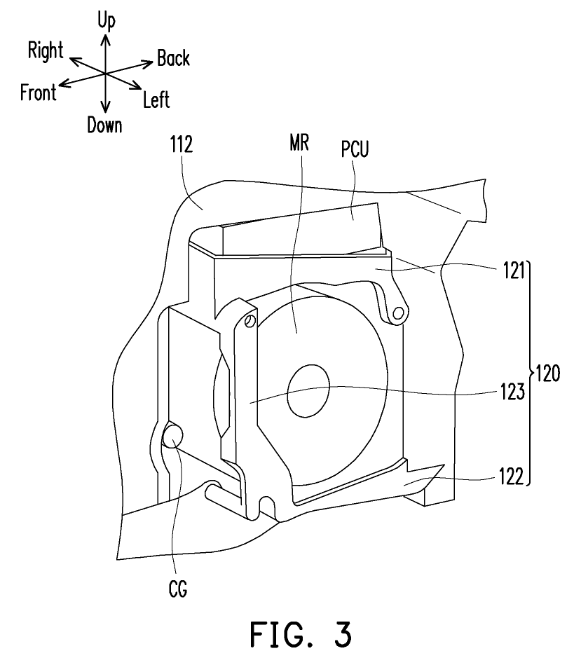

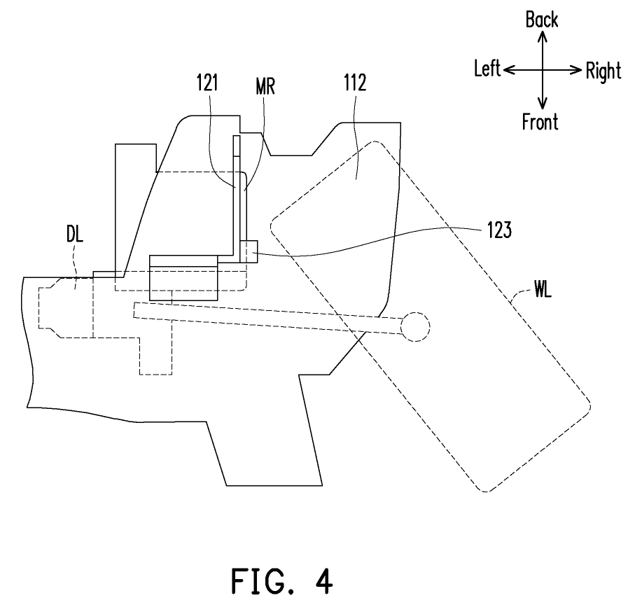

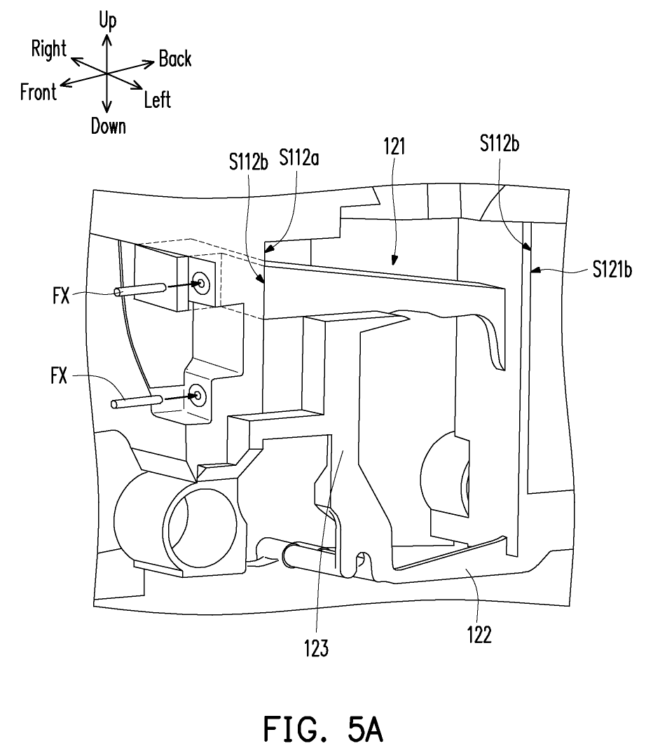

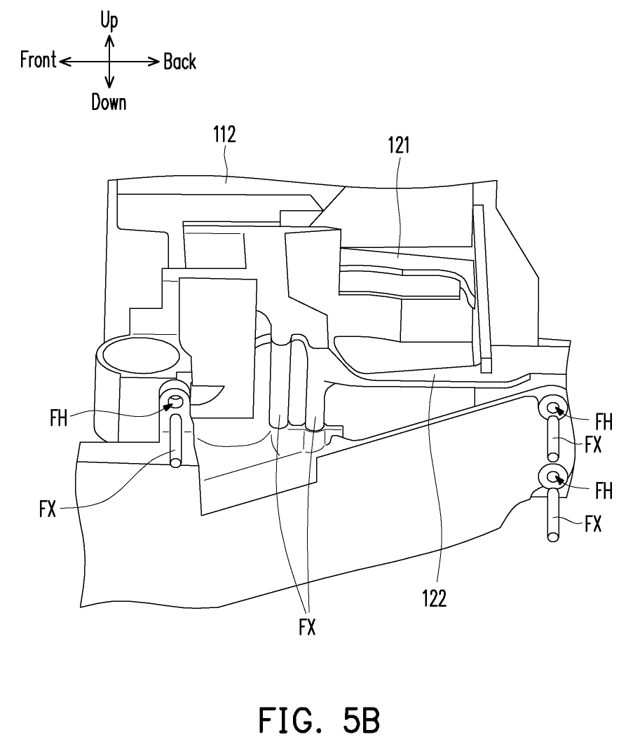

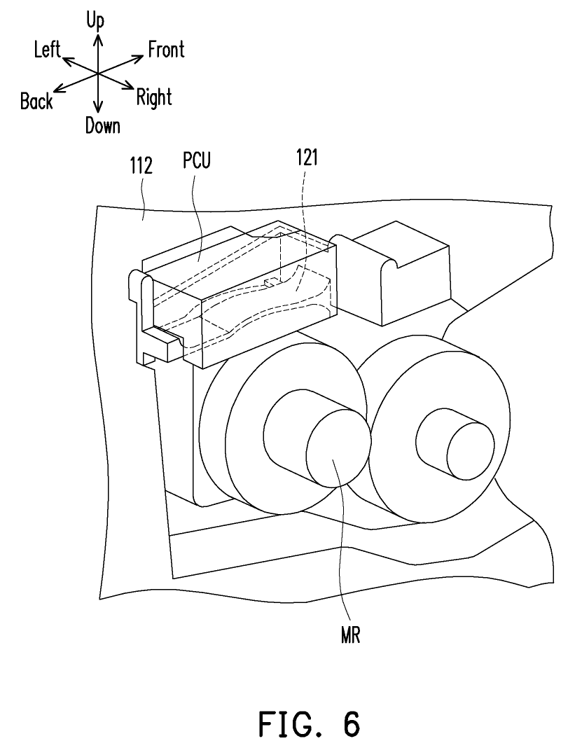

References of the exemplary embodiments of the disclosure are to be made in detail. Examples of the exemplary embodiments are illustrated in the drawings. If applicable, the same reference numerals in the drawings and the descriptions indicate the same or similar parts. FIG. 1 is a schematic diagram of a vehicle front structure according to an embodiment of the disclosure. FIG. 2 is a side view schematic diagram of the vehicle front structure shown in FIG. 1. FIG. 3 is a partially enlarged schematic diagram of the vicinity of the connecting rigid component of the vehicle front structure shown in FIG. 1. FIG. 4 is a top view schematic diagram of the vicinity of the connecting rigid component of the vehicle front structure shown in FIG. 1. FIG. 5A and FIG. 5B are partial schematic diagrams of some mounting parts on the mounting bracket of the vehicle front structure shown in FIG. 1. FIG. 6 is a schematic diagram of the vehicle front structure shown in FIG. 1 equipped with a control unit. It should be noted that, for the sake of convenience, the front and back directions, left and right directions, and up and down directions of the vehicle are defined as shown in the figures. According to this definition, the composition of each part is described, with the front and back directions, left and right directions, and up and down directions corresponding respectively to the vehicle length direction, vehicle width direction, and vehicle height direction.

In one embodiment of the disclosure, the mounting bracket includes an upper mounting bracket located above the electric motor and a lower mounting bracket located below the electric motor. A front load receiving surface is formed on a front surface of the upper mounting bracket, a rear load receiving surface is formed on a rear surface of the upper mounting bracket, a front load transmitting surface is formed on a front surface of the accommodating portion, and a rear load transmitting surface is formed on a rear surface of the accommodating portion. The front load receiving surface is in contact with the front load transmitting surface, and the rear load receiving surface is in contact with the rear load transmitting surface.

In one embodiment of the disclosure, all of the mounting parts for elastically supporting the electric motor are mounted on the mounting bracket.

In one embodiment of the disclosure, the side frame includes a front side frame that is easily deformed when subjected to impact and a rear side frame that is not easily deformed when subjected to impact. The accommodating portion is formed in the rear side frame.

In one embodiment of the disclosure, the mounting bracket includes an upper mounting bracket, a lower mounting bracket, and a connecting rigid component. The upper mounting bracket is located above the electric motor. The lower mounting bracket is located below the electric motor. The connecting rigid component connects the upper mounting bracket and the lower mounting bracket along a vehicle height direction. A differential device is provided next to the electric motor to distribute driving force to a wheel. The connecting rigid component is disposed between an axis of the differential device and an axis of the electric motor in a vehicle length direction.

In one embodiment of the disclosure, a coupling for a rotary transformer is provided on an outer surface of the electric motor, and the connecting rigid component is provided in front of the coupling.

In one embodiment of the disclosure, a control unit for controlling the electric motor is provided above the upper mounting bracket.

Referring to FIG. 1 and FIG. 2, in this embodiment, the vehicle front structure 100 includes a side frame 110, a mounting bracket 120, and a subframe 130. For example, in this embodiment, the side frame 110 and the mounting bracket 120 may be structures formed of die-cast aluminum, but the disclosure is not limited thereto. In another embodiment, the front portion of the side frame 110 may also be formed by extrusion molding. Specifically, as shown in FIG. 1 and FIG. 2, in this embodiment, the side frame 110 is provided with an accommodating portion 112C, and at least a portion of an electric motor MR configured to drive the vehicle is accommodated in the accommodating portion 112C. The mounting bracket 120 is equipped with mounting parts FX for elastically supporting the electric motor MR, and the mounting bracket 120 is configured to span the front portion and the rear portion of the accommodating portion 112C. Furthermore, in this embodiment, the electric motor MR is only disposed on the side frame 110 on one side of the vehicle front structure 100, but the disclosure is not limited thereto. In another embodiment, the vehicle front structure 100 may also have electric motors MR provided on the left and right side frames, respectively. However, in comparison to the scenario where electric motors MR are respective provided on the left and right side frames 110, providing the electric motor MR on the side frame 110 of only one side may reduce costs.

Thus, by accommodating at least a portion of the electric motor MR in the accommodating portion 112C, the space between the left and right side frames 110 may be increased. This allows the interior space of the vehicle, for example, the cabin, to be expanded towards the front compartment accommodating the electric motor MR, thereby ensuring a larger cabin. Furthermore, the mounting bracket 120 may simultaneously function as a support component for mounting the electric motor MR and a reinforcement component for reinforcing the structure. This prevents a reduction in the structural strength of the side frame 110 due to the configuration of an accommodating portion 112C within the side frame 100, and structural rigidity may be ensured while assembling the components in a more compact manner.

Furthermore, as shown in FIG. 1 and FIG. 2, in this embodiment, the side frame 110 includes a front side frame 111 and a rear side frame 112, and the accommodating portion 112C is formed in the rear side frame 112. For example, in this embodiment, the front side frame 111 and the rear side frame 112 may be independent components that are assembled to form the side frame 110, or they may be integrated into a single unitary component. Furthermore, as shown in FIG. 2, in this embodiment, the front side frame 111 is provided with an impact absorption area SA, which is easily deformed when subjected to impact, so it may absorb the impact through deformation, while the rear side frame 112 is formed into a structure that is not easily deformed when subjected to impact. Thus, by forming the accommodating portion 112C in the rear side frame 112, the electric motor MR may be protected from impact.

More specifically, as shown in FIG. 1 and FIG. 3, in this embodiment, the mounting bracket 120 includes an upper mounting bracket 121, a lower mounting bracket 122, and a connecting rigid component 123. The upper mounting bracket 121 is located above the electric motor MR and extends along the vehicle length direction. The lower mounting bracket 122 is located below the electric motor MR and extends along the vehicle length direction. Furthermore, the connecting rigid component 123 connects the upper mounting bracket 121 and the lower mounting bracket 122 along the vehicle height direction.

Furthermore, as shown in FIG. 1 and FIG. 4, in this embodiment, a differential device DL is provided next to the electric motor MR to distribute driving force to the wheel WL, and the connecting rigid component 123 is disposed between the axis of the differential device DL and the axis of the electric motor MR in the vehicle length direction. In this way, this arrangement may prevent any interference with the steering wheels due to the installation of the mounting bracket 120. Furthermore, as shown in FIG. 3, in this embodiment, a coupling CG for a rotary transformer is provided on the outer surface of the electric motor MR, and the connecting rigid component 123 is provided in front of the coupling CG. Thus, by installing the connecting rigid component 123 in this manner, it serves to shield the coupling CG from stones flying from the front, thereby mitigating the risk of damage to the component.

On the other hand, as shown in FIG. 1, FIG. 5A and FIG. 5B, in this embodiment, all mounting parts FX for elastically supporting the electric motor MR are mounted on the mounting bracket 120. For example, the mounting parts FX may be screw fasteners, which may be installed by screwing into the multiple mounting holes FH of the mounting bracket 120. More specifically, in this embodiment, the electric motor MR may be first mounted on the mounting bracket 120, and then the mounting bracket 120 may be securely fastened to the subframe 130. Next, as shown in FIG. 5A and FIG. 5B, the mounting bracket 120 and the subframe 130 equipped with the motor MR are inserted into the accommodating portion 112C of the side frame 110 from below the side frame 110. The subframe 130 and the side frame 110 are then fixed with mounting parts FX in the vehicle length direction (as shown in FIG. 5A). Additionally, the mounting bracket 120 and the side frame 110 are fixed with mounting parts FX from one side of the vehicle front structure 100 in the vehicle width direction (as shown in FIG. 5B). Thus, by using the mounting parts FX to mount the electric motor MR onto the mounting bracket 120, the electric motor MR may be mounted onto the vehicle body at the same time the mounting bracket 120 is mounted onto the vehicle front structure 100, thus simplifying the assembly process.

Furthermore, as shown in FIG. 1 and FIG. 5A, a front load receiving surface S121a is formed on the front surface of the upper mounting bracket 121, a rear load receiving surface S121b is formed on the rear surface of the upper mounting bracket 121, a front load transmitting surface S112a is formed on the front surface of the accommodating portion 112C, and a rear load transmitting surface S112b is formed on the rear surface of the accommodating portion 112C. The front load receiving surface S121a is in contact with the front load transmitting surface S112a, and the rear load receiving surface S121b is in contact with the rear load transmitting surface S112b. Thus, through the contact between the accommodating portion 112C of the side frame 110 and the upper mounting bracket 121 of the mounting bracket 120, a good load transfer path may be established, effectively withstanding impact loads, and facilitating the installation of the electric motor MR. Furthermore, by increasing the contact area between the upper mounting bracket 121 of the mounting bracket 120 and the accommodating portion 112C of the side frame 110, a greater impact load applied to the side frame 110 may be withstood.

Furthermore, as shown in FIG. 3 and FIG. 6, in this embodiment, a control unit PCU for controlling the electric motor MR is provided above the upper mounting bracket 121. Thus, by providing the control unit PCU above the upper mounting bracket 121, the control unit PCU that controls the electric motor MR may be protected from impact during a collision.

To sum up, in an embodiment of the disclosure, the space between the left and right side frames may be increased by accommodating at least a portion of the electric motor in the accommodating portion of the vehicle front structure. This allows the interior space of the vehicle, for example, the cabin, to be expanded towards the front compartment accommodating the electric motor, thereby ensuring a larger cabin. Furthermore, the mounting bracket may simultaneously function as a support component for mounting the electric motor and a reinforcement component for reinforcing the structure. This prevents a reduction in the structural strength of the side frame due to the configuration of an accommodating portion within the side frame, and ensures structural rigidity while assembling the components in a more compact manner, while simultaneously satisfying the ease of assembly and installation functionality.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A vehicle front structure, comprising:
a side frame, provided with an accommodating portion, wherein at least a portion of an electric motor for driving a vehicle is accommodated in the accommodating portion; and
a mounting bracket, equipped with mounting parts for elastically supporting the electric motor,
wherein the mounting bracket is configured to span a front portion and a rear portion of the accommodating portion.

2. The vehicle front structure according to claim 1, wherein,
the mounting bracket comprises an upper mounting bracket located above the electric motor and a lower mounting bracket located below the electric motor,
a front load receiving surface is formed on a front surface of the upper mounting bracket, a rear load receiving surface is formed on a rear surface of the upper mounting bracket,
a front load transmitting surface is formed on a front surface of the accommodating portion, a rear load transmitting surface is formed on a rear surface of the accommodating portion,
the front load receiving surface is in contact with the front load transmitting surface, and the rear load receiving surface is in contact with the rear load transmitting surface.

3. The vehicle front structure according to claim 1, wherein, all of the mounting parts for elastically supporting the electric motor are mounted on the mounting bracket.

4. The vehicle front structure according to claim 1, wherein, the side frame comprises a front side frame that is easily deformed when subjected to impact and a rear side frame that is not easily deformed when subjected to impact, the accommodating portion is formed in the rear side frame.

5. The vehicle front structure according to claim 1, wherein,
the mounting bracket comprises:
an upper mounting bracket, located above the electric motor;
a lower mounting bracket, located below the electric motor; and
a connecting rigid component, connecting the upper mounting bracket and the lower mounting bracket along a vehicle height direction,
a differential device is provided next to the electric motor to distribute driving force to a wheel,
the connecting rigid component is disposed between an axis of the differential device and an axis of the electric motor in a vehicle length direction.

6. The vehicle front structure according to claim 5, wherein, a coupling for a rotary transformer is provided on an outer surface of the electric motor, and the connecting rigid component is provided in front of the coupling.

7. The vehicle front structure according to claim 5, wherein, a control unit for controlling the electric motor is provided above the upper mounting bracket.
